(19) United States
(12) Patent Application Publication
(10) Pub. No.: US 2025/0012382 A1
(43) Pub. Date: Jan. 9, 2025

(54) STEEL PIPE FOR OIL CYLINDER AND MANUFACTURING METHOD THEREFOR

(71) Applicant: Baoshan Iron & Steel Co., Ltd., Shanghai (CN)

(72) Inventors: Wen Sun, Shanghai (CN); Zhan Gao, Shanghai (CN); Yannan Ma, Shanghai (CN); Hongzhi Zuo, Shanghai (CN)

(21) Appl. No.: 18/712,635

(22) PCT Filed: Nov. 24, 2022
(86) PCT No.: PCT/CN2022/134015

§ 371 Date: May 22, 2024

(30) Foreign Application Priority Data
Nov. 25, 2021 (CN) 202111410864.7

(51) Int. Cl. F16L 9/02; C21D 1/25; C21D 1/30; C21D 6/00; C21D 9/08; C22C 38/02; C22C 38/04; C22C 38/12; C22C 38/14

(52) U.S. Cl. CPC F16L 9/02; C21D 1/25; C21D 1/30; C21D 6/005; C21D 6/008; C21D 9/085; C22C 38/02; C22C 38/04; C22C 38/12; C22C 38/14; C21D 2211/005; C21D 2211/009; C22C 2202/00

(57) ABSTRACT

Disclosed is a steel pipe for oil cylinder and a manufacturing method therefor. In addition to 90 wt % or more of Fe and inevitable impurities, the steel pipe for oil cylinder further comprises the following chemical elements in wt %: C: 0.16-0.3%, Si: 0.15-0.5%, Mn: 1.2-1.8%, Nb: 0.02-0.04%, Mo: 0.1-0.2%, and optionally Ti: 0.015-0.03% and B: 0.0015-0.0035%. According to the present invention, after tension reduction and quenching of the steel pipe, different stepped cooling processes are adopted respectively, the distribution of phase change and thermal stress in the whole wall thickness of the steel pipe for oil cylinder is controlled by increasing the rigidity and straightness level of the steel pipe, the distribution of ferrite in the microstructure of the steel pipe for oil cylinder is controlled, the residual stress of the steel pipe for oil cylinder is effectively reduced, cracking of the inner wall is avoided, and therefore the steel pipe for oil cylinder with high strength and low residual stress is obtained. The steel pipe for oil cylinder has a yield strength of greater than or equal to 600 MPa, a tensile strength of greater than or equal to 730 MPa, and a residual stress of less than or equal to 50 MPa.

### TECHNICAL FIELD

The present invention relates to the field of materials, in particular to a steel pipe for oil cylinder and a manufacturing method therefor.

### BACKGROUND

Steel pipe for oil cylinders are widely used in engineering machinery oil cylinder or air cylinder barrels, and bear impulse fatigue, friction and other loads during use. The residual stress is an important factor affecting the fatigue life, resistance to extrusion, resistance to internal pressure, and machining deformation of seamless pipes. Reducing or eliminating the residual stress of the steel pipe for oil cylinders can significantly improve the service life of the steel pipe for oil cylinders, which is one of the important directions in the subsequent control of the production of the steel pipe for oil cylinders.

Currently, the conventional means of reducing or eliminating the residual stress include high temperature stress relief annealing and mechano-physical methods. However, such processes are costly and increase the production process.

Chinese patent CN201810365440.5 discloses “Method for Eliminating Residual Stress of Tempered Seamless Steel Pipe and Adopted Bi-directional Chain Type Cooling Bed”, by controlling the straightness of the steel pipe after rolling and before tempering and a bi-directional chain of the cooling bed after tempering to eliminate the residual stress, the need for tempering and stress-eliminating annealing process is omitted, and the purpose of reducing costs is achieved.

Chinese patent CN201420805596.8 discloses “Asymmetric Steel Pipe Straightening Roller”, which designs a special straightening roller for eliminating residual stress and oxidized skin of a steel pipe by controlling the force on the steel pipe in the straightening process.

Chinese patent CN200910210718.2 discloses “Method for Controlling Residual Stress Level of Conveyor Steel Pipe”, in which a formula is derived, and the residual stress level of the steel pipe is obtained by comparing the measured amount of elastic recovery of the steel pipe with the formula, which is a method of measuring and characterizing the residual stress level of the steel pipe.

### SUMMARY

An objective of the present invention is to provide a steel pipe for oil cylinder and a manufacturing method therefor. Compared with traditional oil cylinder steel pipe products, the present invention can significantly reduce the residual stress of the steel pipe for oil cylinder and avoid cracking of the inner wall, while providing a higher strength. According to the present invention, the yield strength of the steel pipe for oil cylinder is greater than or equal to 600 MPa, the tensile strength is greater than or equal to 730 MPa, and the residual stress is less than or equal to 50 MPa.

In one aspect, the present invention provides a steel pipe for oil cylinder, wherein in addition to 90 wt % or more of Fe and inevitable impurities, the steel pipe for oil cylinder further comprises the following chemical elements in percentage by weight (wt %): C: 0.16-0.3%, Si: 0.15-0.5%, Mn: 1.2-1.8%, Nb: 0.02-0.04%, Mo: 0.1-0.2%, and optionally Ti: 0.015-0.03% and B: 0.0015-0.0035%.

Preferably, the steel pipe for oil cylinder comprises the following chemical elements in wt %: C: 0.16-0.3%, Si: 0.15-0.5%, Mn: 1.2-1.8%, Nb: 0.02-0.04%, Mo: 0.1-0.2%, and optionally Ti: 0.015-0.03% and B: 0.0015-0.0035%, the balance being Fe and inevitable impurities.

Preferably, among the inevitable impurities, P≤0.01% and S≤0.001%.

In some embodiments, the steel pipe for oil cylinder has a wall thickness of greater than or equal to 20 mm, and the steel pipe for oil cylinder comprises Ti: 0.015-0.03% and B: 0.0015-0.0035%. In some embodiments, a wall thickness of the steel pipe for oil cylinder is less than 20 mm, and the steel pipe for oil cylinder may comprise or not comprise Ti: 0.015-0.03% and B: 0.0015-0.0035%.

Preferably, the wall thickness of the steel pipe for oil cylinder is greater than or equal to 9 mm.

Preferably, in the wall thickness direction of the steel pipe for oil cylinder, a microstructure from the outer wall to the t/2 position is tempered sorbite; a microstructure from the t/2 position to the inner wall is tempered sorbite+ferrite, the ferrite is distributed in a gradient, and the closer a distance to the inner wall is, the higher the content of the ferrite is; and the content of ferrite in the microstructure at the t/2 position is greater than or equal to 3%, and the content of the ferrite in the microstructure at the inner wall (i.e., at the surface of the inner wall) is greater than or equal to 5%.

Herein, t denotes the wall thickness (in mm) of the steel pipe for oil cylinder, unless explicitly stated otherwise.

Preferably, the yield strength of the steel pipe for oil cylinder is greater than or equal to 600 MPa, the tensile strength is greater than or equal to 730 MPa, and the residual stress is less than or equal to 50 MPa.

Preferably, the residual stress of the steel pipe for oil cylinder is less than or equal to 40 MPa.

Preferably, the steel pipe for oil cylinder has a yield-to-tensile ratio (i.e., a ratio of the yield strength to the tensile strength) of less than or equal to 0.92.

Preferably, a content of ferrite in the microstructure at the t/2 position of the steel pipe for oil cylinder of the present invention is 0.5 t to 1.0 t %.

Preferably, the content of the ferrite in the microstructure at the inner wall of the steel pipe for oil cylinder of the present invention is 1.5 t to 2.0 t %.

Herein, the content of ferrite is defined as the percentage of ferrite in the microstructure in terms of area % and is determined according to metallographic method.

In the steel pipe for oil cylinder of the present invention, the elements are designed based on the following principle:

C: C is an interstitial solid solution strengthening element and has a large effect on hardenability. When the content of C is less than 0.16%, the strength is too low; and when the content of C is higher than 0.3%, cracking occurs in the inner wall after stepped cooling. Thus, the content of C in the present invention is controlled to be in the range of 0.16 to 0.3%.

Si: Si is a commonly used deoxidizer, is also a strong iron precipitating element, and improves hardenability to some extent. When the content of Si is less than 0.15%, the above effects cannot be fully realized; and when the content of Si is higher than 0.5%, Si causes surface quality problems. Thus, the content of Si in the present invention is controlled to be in the range of 0.15 to 0.5%.

Mn: Mn is a solid solution strengthening element and also a strong hardenability enhancing element. When the content of Mn is less than 1.2%, the hardenability is insufficient, and the strength is low; and when the content of Mn is greater than 1.8%, the hardenability is too high, resulting in the precipitation of the content of ferrite from the t/2 position to the inner wall after stepped cooling is less, and the phase change and thermal stress of the inner wall are both significant tensile stresses, resulting in cracking of the inner wall. Thus, the content of Mn in the present invention is controlled to be in the range of 1.2 to 1.8%.

Nb: Nb is a carbide precipitation strengthening element, refines austenite grains and acts as a nucleation point to promote ferrite precipitation during stepped cooling.

Mo: Mo strongly enhances hardenability as well as strong toughness matching and tempering stability. When the content of Mo is in the range of 0.1% to 0.2%, the ferrite from the t/2 position to the inner wall is controlled to be distributed in a gradient through the effect of Mo on the hardenability, and the strength is ensured while the inner wall cracking in the stepped cooling process is avoided.

Ti and B: Compound addition of Ti and B strongly enhances hardenability. For pipes with the wall thickness of 20 mm or more, it is needed to improve the hardenability of the steel pipe for oil cylinder, and to avoid the content of ferrite from the t/2 position to the inner wall from being increased significantly and resulting in low strength. Meanwhile, Ti, precipitated as carbonitride, can serve as a nucleation point of ferrite in the stepped cooling process, and can effectively control the proportion of ferrite precipitation. When the content of Ti is less than 0.015% or the content of B is less than 0.0015%, the above effects cannot be fully realized; and when the content of Ti is higher than 0.03% or the content of B is higher than 0.0035%, there is no significant enhancement for improving the hardenability. Therefore, the content of Ti in the present invention is controlled to be in the range of 0.015 to 0.03%, and the content of B is controlled to be in the range of 0.0015 to 0.0035%.

It should be noted that inevitable impurities include P and S, both of which are harmful elements in steel. Too high a mass percentage of P may bias grain boundaries, embrittle grain boundaries, and seriously deteriorate toughness. Too high a mass percentage of S leads to an increase in the amount of inclusions in the steel, which is detrimental to low-temperature toughness. Therefore, the content of P and S in the steel should be minimized.

The present invention controls the distribution of ferrite in the steel pipe for oil cylinder by controlling the content of elements such as Nb, Mo and Ti. In the wall thickness direction of the steel pipe for oil cylinder, the microstructure from the outer wall to the t/2 position is tempered sorbite: the microstructure from the t/2 position to the inner wall is tempered sorbite+ferrite, wherein the ferrite is distributed in a gradient, and the closer a distance to the inner wall is, the higher the content of the ferrite is. The content of ferrite in the microstructure at the t/2 position is greater than or equal to 3%, and the content of the ferrite in the microstructure at the inner wall is greater than or equal to 5%. Herein, t is the wall thickness in mm of the steel pipe for oil cylinder. The microstructure from the outer wall to the t/2 position is tempered sorbite, and the tempered sorbite has a good strength and toughness level, and ensures sufficient rigidity of the outer layer of the steel pipe for oil cylinder. The microstructure from the t/2 position to the inner wall is tempered sorbite+ferrite, which can ensure good toughness and low yield-to-tensile ratio of the steel pipe for oil cylinder.

In addition, precipitation of the ferrite structure is distributed in a gradient, and the closer the distance to the inner wall is, the higher the content of ferrite is. Since ferrite has good ductility and toughness, it can ensure that the inner wall of the steel pipe for oil cylinder has good residual stress control in the cooling process, preventing the inner wall from cracking in the water quenching process, and the residual stress of the steel pipe for oil cylinder can be significantly reduced while ensuring that the steel pipe for oil cylinder has a high strength.

The inventors have found, through extensive research, that the precipitation amount of ferrite in the steel pipe for oil cylinder is directly related to the wall thickness of the steel pipe for oil cylinder in a specific way. The content of ferrite at the t/2 position of the wall thickness ranges from 0.5 t to 1.0 t %, and the content of ferrite in the microstructure at the inner wall of the steel pipe for oil cylinder ranges from 1.5 t to 2.0 t %. If the content of ferrite is too low, the yield-to-tensile ratio is too high, the residual stress is too large, use safety is reduced, and in addition, a greater risk of cracking of the inner wall during water quenching is caused. If the content of ferrite is too high, the strength of the steel pipe for oil cylinder is too low, and the requirements for use cannot be met; when the wall thickness increases, if no enough ferrite is precipitated, it will lead to an increase in the residual stress of the steel pipe for oil cylinder, and there is a strong tendency for inner wall cracking.

In another aspect, the present invention provides a method for manufacturing the above-mentioned steel pipe for oil cylinder, including the following steps:

(1) smelting and casting:
smelting and casting molten steel having an elemental composition as recited above to obtain a cast billet:
   (2) heating the cast billet:
   (3) perforating the heated cast billet:
   (4) continuously rolling the perforated cast billet to obtain a steel pipe:
   (5) forced-air-cooling and reheating the steel pipe:
   (6) performing tension reduction and cooling on the reheated steel pipe:

performing tension reduction (i.e., stretch reducing) on the reheated steel pipe, performing water cooling only on the outer wall of the steel pipe after the tension reduction (i.e., not water cooling the inner wall of the steel pipe in this step), and controlling the starting cooling temperature of the steel pipe to be ≥Ar3, and the finishing cooling temperature of the steel pipe to be ≥Br and ≤ Bₛ−100° C., and the cooling rate in a range of 25 to 35° C./s:

(7) straightening the cooled steel pipe:
(8) quenching the straightened steel pipe:
heating the straightened steel pipe to Ac₃+30 to Ac₃+60° C. (i.e., quenching temperature is controlled to be Ac₃+30≤ and ≤Ac₃+60° C.), and following the quenching, stepped cooling is performed by means of water cooling while rotating the steel pipe, wherein the water cooling is carried out by performing external water spraying first, and when Ar₃−70° C. ≤ inner wall temperature≤ less than Ar₃−30° C., water is injected into the steel pipe from one end of the steel pipe until the inner hole of the steel pipe is filled with cooling water, and the steel pipe is cooled to room temperature:
   (9) tempering the quenched steel pipe; and
   (10) straightening the steel pipe after being discharged from a furnace to obtain the steel pipe for oil cylinder.

Preferably, in step (2), the heating is performed at a temperature of 1250 to 1280° C. for 3 to 4 h.

Preferably, in step (3), the perforating is performed at a temperature of 1100 to 1230° C.

Preferably, in step (4), the finishing rolling is performed at a temperature of 900 to 1000° C.

Preferably, in step (5), the steel pipe is forced-air-cooled to Ar₃−50° C. or lower, and then is reheated to 950 to 980° C.

Preferably, in step (6), the tension reduction is performed at a temperature of 850 to 900° C.

Preferably, in step (7), the straightened steel pipe is allowed to be cooled naturally to room temperature.

Preferably, in step (9), the tempering is performed at a temperature of (550-2×t° C.)

Preferably, in step (10), the straightening is performed at a temperature of ≥400° C.

The present invention designs the composition of the steel pipe for oil cylinder and controls the cooling process during water quenching, such that the residual stress of the steel pipe for oil cylinder can be reduced and the use performance of the steel pipe for oil cylinder can be improved without adding additional production processes.

The steel pipe is subjected to tension reduction at 850 to 900° C.: water cooling is performed only on the outer wall of the steel pipe after the tension reduction: the starting cooling temperature is controlled to be ≥Ar₃, and the finishing cooling temperature is controlled to be ≥B_{f} and ≤Bₛ−100° C., wherein Br is the temperature at the end of phase change of bainite in the cooling process, and Bₛ is the temperature at the start of phase change of bainite in the cooling process; and the cooling rate is controlled to be 25 to 35° C./s in the cooling process. The main purpose of such process is to make the steel pipe cool and harden quickly through uniform cooling, which ensures that the straightness of the steel pipe is less than or equal to 2 mm/m, preferably less than 1.5 mm/m, and at the same time refines the rolled state structure, which lays a foundation for obtaining good performance matching after subsequent tempering. In addition, the residual stress level in the rolled state is reduced by cooling in this manner.

The steel pipe is immediately straightened after being rapidly cooled to the finishing cooling temperature, straightening with temperature is conducive to ensuring the straightness, the residual stress level in the rolled state is reduced, the straightness of the straightened steel pipe is less than or equal to 2 mm/m, preferably less than 1.5 mm/m, and then the steel pipe is fed on a cooling bed to be allowed to be cooled naturally to room temperature.

The steel pipe of the present invention is water-cooled for stepped cooling after quenching, the steel pipe is rotated in the cooling process: during cooling, the outer wall of the steel pipe is cooled first by external water spray, and when Ar₃−70° C. ≤ inner wall temperature≤ less than Ar₃−30° C., internal water spaying is turned on to inject water into the steel pipe to cool the inner wall of the steel pipe, until the inner hole of the steel pipe is filled with cooling water, and the steel pipe is cooled to room temperature.

The present invention performs cooling to the steel pipe for oil cylinder by the stepped cooling process based on the following principles:

1) As the external water spraying cools the entire length of the steel pipe at the same time, the cooling uniformity is good, while performing cooling to the inner wall of the steel pipe, one end of the steel pipe is cooled first, the other end is cooled later, so that the rigidity of the steel pipe is increased, the good cooling uniformity ensures the better straightness level of the steel pipe, and large residual stress caused by straightening deformation due to subsequent bending of the pipe is avoided.

2) The residual stress of the steel pipe is closely related to the phase change and thermal stress in the cooling process. The stepped cooling can effectively control the distribution of phase change and thermal stress throughout the whole wall thickness of the steel pipe, realize the mutual elimination of phase change stress and thermal stress of martensite, and effectively reduce the residual stress level of the steel pipe. In the technical solution of the present invention, by using a stepped cooling method in which external water spraying is followed by internal water spraying, for the outer wall of the steel pipe, the phase change stress is tensile stress and the thermal stress is compressive stress, and for the center of the steel pipe, the phase change stress is compressive stress and the thermal stress is tensile stress, and the two can cancel each other out.

3) The cooling transformation structure of inner wall precipitates part of the ferrite structure, rather than a completely martensitic structure, which can effectively reduce the residual stress of the inner wall. In the technical solution of the present invention, the phase change stress and thermal stress of inner wall are both tensile stress, but the inner wall is a late-cooled surface. The cooling of inner wall is started after external water spraying cooling and when Ar₃−70° C. ≤ the inner wall temperature≤ Ar₃−30° C. At this time, the ferrite structure has precipitated in the inner wall, a transformation proportion of the martensitic structure is reduced, the phase change stress at the inner wall is reduced, and accordingly the residual stress level of the inner wall is effectively reduced, and cracking of the inner wall is avoided.

In the present invention, rapid cooling is adopted for the cooling process post tension reduction, to increase the hardness and uniformity of the steel pipe for oil cylinder and reduce the residual stress level in the steel pipe for oil cylinder in the rolled state. Further, through the stepped cooling after quenching, the cold rate gradient is formed in the wall thickness direction. In the cooling process, the outer wall is first cooled, the center and the inner wall are then cooled. The cooling rate of the center and the inner wall is slower than that of the outer wall. The ferrite structure transformation first occurs, and then martensite transformation occurs. As closer to the inner wall, the cooling rate is gradually slowed down, and the precipitation content of ferrite increases. Moreover, with the increase in the wall thickness of the steel pipe for oil cylinder, the cooling rate of the center and the inner wall is further reduced, the precipitation of ferrite is promoted, and the precipitation content of ferrite will increase accordingly.

When Ar₃−70° C. ≤ the inner wall temperature≤ Ar₃−30° C., water is injected to the inner wall for cooling: at this time, the inner wall has precipitated the ferrite structure, the proportion of martensitic structure transformation is reduced, and thus the residual stress level within 1 mm from the inner wall is effectively reduced.

The present invention controls the precipitation of ferrite in the microstructure of the steel pipe for oil cylinder through the stepped cooling process, and the closer to the inner wall, the higher the content of ferrite. Since ferrite has good ductility and toughness, it can ensure good control of the residual stress of inner wall of the steel pipe for oil cylinder during cooling, and avoid the inner wall from cracking in the water quenching process.

The present invention exhibits the following beneficial effects:

In the composition design of the steel pipe for oil cylinder of the present invention, the hardenability of the steel pipe for oil cylinder is improved by controlling the content of the elements C, Si, and Mn, so as to avoid cracking of the inner wall of the steel pipe for oil cylinder in the subsequent stepped cooling process. Meanwhile, the distribution of ferrite in the steel pipe for oil cylinder is controlled by controlling the content of Nb and Mo elements, which further avoids the cracking of the inner wall in the stepped cooling process.

In addition, depending on the wall thickness of the steel pipe for oil cylinder, Ti and B may be added to enhance the hardenability, which can avoid that the content of ferrite from the t/2 position to the inner wall is greatly increased and causes low strength, when the wall thickness of the steel pipe for oil cylinder is 20 mm or more.

According to the present invention, on the basis of the composition design, different stepped cooling processes are adopted respectively, after the steel pipe is subjected to tension reduction and quenching. On one hand, large residual stress caused by straightening deformation due to subsequent bending of the pipe is avoided by increasing the rigidity and straightness level of the steel pipe. On the other hand, by controlling the distribution of phase change and thermal stress throughout the whole wall thickness of the steel pipe for oil cylinder, the mutual elimination of martensite phase change stress and thermal stress can be realized, and the residual stress level of the steel pipe can be effectively reduced. Finally, by controlling the distribution of ferrite in the microstructure of the steel pipe for oil cylinder, the phase change stress at the inner wall is reduced, the residual stress level of the inner wall is effectively reduced, cracking of the inner wall is avoided, and therefore the steel pipe for oil cylinder with high strength and low residual stress is obtained. The yield strength of the steel pipe for oil cylinder is greater than or equal to 600 MPa, the tensile strength is greater than or equal to 730 MPa, and the residual stress is greater than or equal to 0 and less than or equal to 50 MPa.

### BRIEF DESCRIPTION OF THE DRAWINGS

FIG. 1 is a picture of measuring residual stress of the steel pipe for oil cylinder prepared by Comparative Example 1 of the present invention through a slitting method.

FIG. 2 is a picture of measuring residual stress of the steel pipe for oil cylinder prepared by Example 1 of the present invention through a slitting method.

FIG. 3 is a photograph of the metallographic structure of the outer wall surface of the steel pipe for oil cylinder of Example 1 of the present invention.

FIG. 4 is a photograph of the metallographic structure at the position with ½ wall thickness of the steel pipe for oil cylinder of Example 1 of the present invention.

FIG. 5 is photograph of the metallographic structure of the inner wall surface of the steel pipe for oil cylinder of Example 1 of the present invention.

### DETAILED DESCRIPTION

The present invention is further illustrated below in conjunction with the examples.

Steel pipes for oil cylinder in Examples 1-8 of the present invention were manufactured according to the method described above. Steel pipes for oil cylinder in Comparative Examples 1-8 were manufactured using substantially the same method as that in Examples 1-8, but one or more of the element compositions and/or manufacturing process parameters of Comparative Examples 1-8 did not fall within the protection scope of the present invention.

Chemical compositions of Examples 1-8 and Comparative Examples 1-8 of the present invention are shown in Table 1.

Specific manufacturing process parameters of Examples 1-8 and Comparative Examples 1-8 of the present invention are shown in Table 2. In step (1), molten steel was smelted and cast according to the element composition shown in Table 1 to obtain a cast billet; and in step (7), the treated steel pipe obtained in step (6) was straightened, and the straightened steel pipe was allowed to be cooled naturally to room temperature.

Performance parameters of steel pipes for oil cylinder obtained in Examples 1-8 and Comparative Examples 1-8 of the present invention are shown in Table 3.

In the present application, yield strength and tensile strength are measured according to GB/T 228, and residual stress is measured according to ISO/TR 10400 standard.

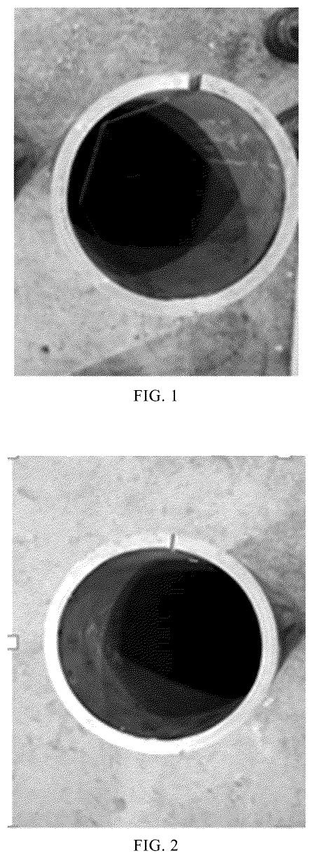

FIG. 1 and FIG. 2 are pictures of measuring residual stress of steel pipes for oil cylinder prepared by Comparative Example 1 and Example 1 of the present invention by a slitting method, respectively. As can be seen from the figures, the residual stress of the steel pipe for oil cylinder of the present invention was significantly smaller than that of the conventional steel pipe for oil cylinder, a slit of the seamless pipe obtained by the method of the present invention was smaller than that of the seamless pipe prepared by a conventional process, and it is obvious that the residual stress of the seamless pipe obtained by the present invention (e.g., Example 1) was significantly smaller than that of the seamless pipe prepared by the conventional process (e.g., Comparative Example 1).

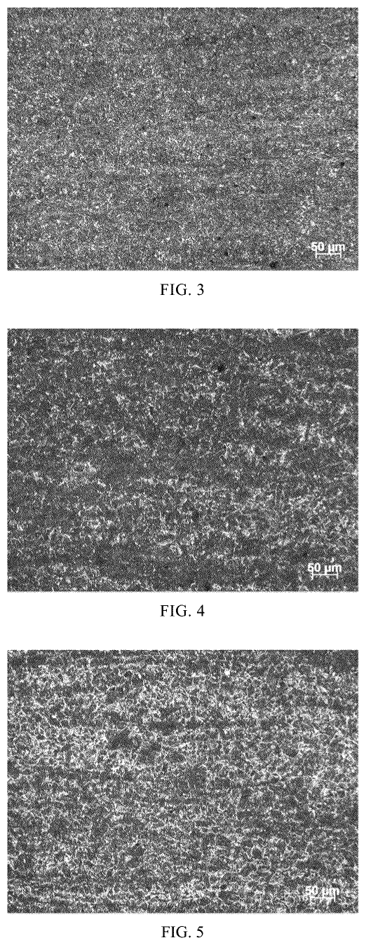

FIG. 3 to FIG. 5 are photographs of metallographic structures of different parts of the steel pipe for oil cylinder of the present invention. As can be seen from the pictures, the metallographic structure from the outer wall to the t/2 position was tempered sorbite, and a t % proportion of ferrite structure was precipitated at the t/2 position. Ferrite from the t/2 position to the inner wall was distributed in a gradient. The closer the distance to the inner wall, the higher the content of ferrite was. The content of ferrite in the metallographic structure at the inner wall reached 2 t %.

As can be seen from Table 3, there was no cracking in the inner wall of the steel pipe for oil cylinder obtained by the present invention, and the residual stress was lower than 50 MPa, and even the residual stress can be as low as 0.

As one or more of the element compositions and/or manufacturing process parameters did not fall within the protection scope of the present invention, the steel pipes for oil cylinder obtained in Comparative Examples 1-8 exhibited higher residual stress and the inner wall may also crack. In the case of the wall thickness being more than 20 mm, in Comparative Examples 4 and 5, due to the lack of addition of the elements Ti and B, the strength of the steel pipes for oil cylinder failed to fulfill the requirements of the present invention, even though the steel pipes for oil cylinder had low residual stress.

In summary, compared with the prior art, the present invention has obtained the steel pipe for oil cylinder with excellent comprehensive performance by designing the chemical element composition of the steel pipe for oil cylinder in combination with a specific manufacturing process.

TABLE 1
(Unit: percentage by weight)

| No. | C | Si | Mn | Nb | Mo | Ti | B |
|---|---|---|---|---|---|---|---|
| Example 1 | 0.20 | 0.16 | 1.2 | 0.020 | 0.10 | — | — |
| Example 2 | 0.16 | 0.25 | 1.4 | 0.033 | 0.15 | — | — |
| Example 3 | 0.25 | 0.35 | 1.6 | 0.025 | 0.20 | — | — |
| Example 4 | 0.30 | 0.50 | 1.5 | 0.040 | 0.16 | 0.02 | 0.0025 |
| Example 5 | 0.21 | 0.45 | 1.7 | 0.027 | 0.17 | 0.015 | 0.003 |
| Example 6 | 0.24 | 0.30 | 1.8 | 0.030 | 0.12 | — | — |
| Example 7 | 0.16 | 0.28 | 1.3 | 0.034 | 0.13 | — | — |
| Example 8 | 0.28 | 0.32 | 1.52 | 0.022 | 0.14 | — | — |
| Comparative | 0.32 | 0.25 | 1.6 | 0.03 | 0.15 | — | — |
| Example 1 | | | | | | | |
| Comparative | 0.2 | 0.26 | 1.9 | 0.02 | 0.16 | — | — |
| Example 2 | | | | | | | |
| Comparative | 0.21 | 0.31 | 1.5 | 0.03 | 0.3 | — | — |
| Example 3 | | | | | | | |
| Comparative | 0.22 | 0.27 | 1.3 | 0.04 | 0.18 | — | — |
| Example 4 | | | | | | | |
| Comparative | 0.25 | 0.3 | 1.6 | 0.04 | 0.17 | — | — |
| Example 5 | | | | | | | |
| Comparative | 0.26 | 0.32 | 1.7 | 0.02 | 0.15 | — | — |
| Example 6 | | | | | | | |
| Comparative | 0.21 | 0.32 | 1.5 | 0.03 | 0.12 | — | — |
| Example 7 | | | | | | | |
| Comparative | 0.18 | 0.26 | 1.6 | 0.025 | 0.13 | — | — |
| Example 8 | | | | | | | |

TABLE 2

| | | | | | Step (4) | Step (5) | | Step (6) |
|---|---|---|---|---|---|---|---|---|
| | | Step (2) | | Step (3) | Finishing | Temperature | | Tension |
| | Wall | Heating | Heating | Perforating | rolling | after forced- | Reheating | reduction |
| | thickness | temperature | time | temperature | temperature | air-cooling | temperature | temperature |
| No. | [mm] | [° C.] | [h] | [° C.] | [° C.] | [° C.] | [° C.] | [° C.] |
| Example 1 | 10 | 1250 | 3.9 | 1150 | 1000 | 700 | 950 | 850 |
| Example 2 | 15 | 1260 | 3.5 | 1210 | 900 | 680 | 960 | 865 |
| Example 3 | 14 | 1270 | 3.1 | 1180 | 950 | 650 | 970 | 875 |
| Example 4 | 25 | 1280 | 3.3 | 1100 | 910 | 600 | 980 | 880 |
| Example 5 | 20 | 1275 | 3.0 | 1220 | 920 | 550 | 965 | 900 |
| Example 6 | 19 | 1265 | 3.8 | 1170 | 960 | 640 | 955 | 885 |
| Example 7 | 9 | 1255 | 4.0 | 1110 | 980 | 620 | 975 | 870 |
| Example 8 | 12 | 1268 | 3.6 | 1230 | 990 | 500 | 968 | 860 |
| Comparative | 12 | 1250 | 3.5 | 1180 | 975 | 530 | 970 | 850 |
| Example 1 | | | | | | | | |
| Comparative | 15 | 1255 | 4.0 | 1190 | 960 | 630 | 975 | 860 |
| Example 2 | | | | | | | | |
| Comparative | 14 | 1260 | 3.8 | 1130 | 950 | 660 | 985 | 870 |
| Example 3 | | | | | | | | |
| Comparative | 25 | 1265 | 3.6 | 1120 | 950 | 670 | 988 | 880 |
| Example 4 | | | | | | | | |
| Comparative | 20 | 1270 | 3.0 | 1115 | 930 | 680 | 985 | 890 |
| Example 5 | | | | | | | | |
| Comparative | 13 | 1280 | 4.0 | 1140 | 940 | 690 | 965 | 900 |
| Example 6 | | | | | | | | |
| Comparative | 16 | 1265 | 3.5 | 1150 | 980 | 520 | 975 | 875 |
| Example 7 | | | | | | | | |
| Comparative | 9 | 1275 | 3.5 | 1190 | 970 | 510 | 980 | 895 |
| Example 8 | | | | | | | | |

| | Step (6) | | | | | | |
|---|---|---|---|---|---|---|---|
| | Starting | Finishing | | Step (8) | | Step (9) | Step (10) |
| | cooling | cooling | Cooling | Quenching | Inner wall | Tempering | Straightening |
| | temperature | temperature | rate | temperature | temperature | temperature | temperature |
| No. | [° C.] | [° C.] | [° C./s] | [° C.] | [° C.] | [° C.] | [° C.] |
| Example 1 | 840 | 380 | 25 | 903 | 720 | 530 | 410 |
| Example 2 | 850 | 390 | 26 | 885 | 750 | 520 | 420 |
| Example 3 | 860 | 400 | 27 | 890 | 730 | 522 | 430 |
| Example 4 | 865 | 430 | 28 | 905 | 740 | 500 | 450 |
| Example 5 | 855 | 450 | 30 | 880 | 725 | 510 | 460 |
| Example 6 | 867 | 395 | 32 | 870 | 735 | 512 | 420 |
| Example 7 | 900 | 420 | 35 | 900 | 739 | 532 | 440 |
| Example 8 | 880 | 385 | 31 | 910 | 745 | 526 | 455 |
| Comparative | 890 | 450 | 29 | 900 | 710 | 526 | 415 |
| Example 1 | | | | | | | |
| Comparative | 870 | 420 | 35 | 900 | 715 | 520 | 420 |
| Example 2 | | | | | | | |
| Comparative | 830 | 410 | 26 | 900 | 720 | 522 | 410 |
| Example 3 | | | | | | | |
| Comparative | 850 | 360 | 27 | 900 | 735 | 500 | 420 |
| Example 4 | | | | | | | |
| Comparative | 860 | 550 | 29 | 900 | 740 | 510 | 425 |
| Example 5 | | | | | | | |
| Comparative | 870 | 150 | 34 | 900 | 745 | 524 | 430 |
| Example 6 | | | | | | | |
| Comparative | 890 | 370 | 32 | 900 | 650 | 518 | 425 |
| Example 7 | | | | | | | |
| Comparative | 900 | 385 | 31 | 900 | 850 | 532 | 410 |
| Example 8 | | | | | | | |

TABLE 3

| | Yield | Tensile | Residual | | |
|---|---|---|---|---|---|
| | Strength | Strength | Stress | Inner Wall | |
| No. | [MPa] | [MPa] | [MPa] | Cracking | Note |
| Example 1 | 650 | 750 | 10 | No | — |
| Example 2 | 640 | 750 | 15 | No | — |
| Example 3 | 660 | 775 | 0 | No | — |
| Example 4 | 665 | 790 | 12 | No | Wall thickness 25 mm, |
| | | | | | adding Ti and B |
| Example 5 | 645 | 760 | 5 | No | Wall thickness 20 mm, |
| | | | | | adding Ti and B |
| Example 6 | 670 | 790 | 20 | No | — |
| Example 7 | 700 | 810 | 30 | No | — |
| Example 8 | 640 | 780 | 25 | No | — |
| Comparative | 810 | 920 | 45 | Yes | C content being too high |
| Example 1 | | | | | |
| Comparative | 790 | 910 | 80 | Yes | Mn content being too high |
| Example 2 | | | | | |
| Comparative | 812 | 915 | 102 | Yes | Mo content being too high |
| Example 3 | | | | | |
| Comparative | 603 | 706 | 21 | No | Wall thickness 25 mm, |
| Example 4 | | | | | not adding Ti and B |
| Comparative | 665 | 795 | 53 | No | Wall thickness 20 mm, |
| Example 5 | | | | | not adding Ti and B, and |
| | | | | | finishing cooling temperature |
| | | | | | after rolling being too high |
| Comparative | 815 | 932 | 150 | No | Finishing cooling temperature |
| Example 6 | | | | | being too low |
| Comparative | 580 | 690 | 98 | No | Temperature of inner wall |
| Example 7 | | | | | before cooling being too low |
| Comparative | 680 | 802 | 35 | Yes | Temperature of inner wall |
| Example 8 | | | | | before cooling being too high |

1. A steel pipe for oil cylinder, wherein in addition to 90 wt % or more of Fe and inevitable impurities, the steel pipe for oil cylinder further comprises the following chemical elements in wt %: C: 0.16-0.3%, Si: 0.15-0.5%, Mn: 1.2-1.8%, Nb: 0.02-0.04%, Mo: 0.1-0.2%, and optionally Ti: 0.015-0.03% and B: 0.0015-0.0035%.

2. The steel pipe for oil cylinder according to claim 1, wherein the steel pipe for oil cylinder comprises the following chemical elements in wt %: C: 0.16-0.3%, Si: 0.15-0.5%, Mn: 1.2-1.8%, Nb: 0.02-0.04%, Mo: 0.1-0.2%, and optionally Ti: 0.015-0.03% and B: 0.0015-0.0035%, the balance being Fe and inevitable impurities.

3. The steel pipe for oil cylinder according to claim 1, wherein the steel pipe for oil cylinder has a wall thickness of greater than or equal to 20 mm, and the steel pipe for oil cylinder comprises Ti: 0.015-0.03% and B: 0.0015-0.0035%.

4. The steel pipe for oil cylinder according to claim 1, wherein in a wall thickness direction of the steel pipe for oil cylinder, a microstructure from an outer wall to a t/2 position is tempered sorbite; a microstructure from the t/2 position to an inner wall is tempered sorbite+ferrite, and the ferrite is distributed in a gradient, and the closer a distance to the inner wall is, the higher the content of the ferrite is; the content of ferrite in the microstructure at the t/2 position is greater than or equal to 3%, and the content of the ferrite in the microstructure at the inner wall is greater than or equal to 5%; wherein t is the wall thickness in mm of the steel pipe for oil cylinder.

5. The steel pipe for oil cylinder according to claim 1, wherein the steel pipe for oil cylinder has a yield strength of greater than or equal to 600 MPa, a tensile strength of greater than or equal to 730 MPa, and a residual stress of less than or equal to 50 MPa, preferably less than or equal to 40 MPa; and preferably, the steel pipe for oil cylinder has a yield-to-tensile ratio of less than or equal to 0.92.

6. The steel pipe for oil cylinder according to claim 1, wherein the content of the ferrite in the microstructure at the t/2 position of the steel pipe for oil cylinder is 0.5 t to 1.0 t %.

7. The steel pipe for oil cylinder according to claim 1, wherein the content of the ferrite in the microstructure at the inner wall of the steel pipe for oil cylinder is 1.5 t to 2.0 t %.

8. The steel pipe for oil cylinder according to claim 1, wherein the wall thickness of the steel pipe for oil cylinder is greater than or equal to 9 mm.

9. A method for manufacturing the steel pipe for oil cylinder according to claim 1, comprising the following steps:
(1) smelting and casting:
smelting and casting molten steel having an elemental composition recited in claim 1 to obtain a cast billet;
(2) heating the cast billet;
(3) perforating the heated cast billet;
(4) continuously rolling the perforated cast billet to obtain a steel pipe;
(5) forced-air-cooling and reheating the steel pipe;
(6) performing tension reduction and cooling on the reheated steel pipe:
wherein water cooling is performed on an outer wall of the steel pipe after the tension reduction, and starting cooling temperature of the steel pipe is controlled to be ≥Ar₃, and finishing cooling temperature of the steel pipe is controlled to be ≥Br and ≤Bₛ−100° C., and cooling rate is controlled to be in a range of 25 to 35° C./s;
(7) straightening the cooled steel pipe;
(8) quenching the straightened steel pipe:
wherein quenching temperature is controlled to be Ac₃+30≤ and ≤Ac₃+60° C., and following the quenching, stepped cooling is performed by means of water cooling while rotating the steel pipe, wherein the water cooling is carried out by performing external water spraying first, and when Ar₃−70° C. ≤ inner wall temperature≤ less than Ar₃−30° C., water is injected into the steel pipe from one end of the steel pipe until the inner hole of the steel pipe is filled with cooling water, and the steel pipe is cooled to room temperature;
(9) tempering the quenched steel pipe; and
(10) straightening the steel pipe after being discharged from a furnace to obtain the steel pipe for oil cylinder.

10. The method according to claim 9, wherein the method meets one or more of the following conditions:
in step (2), the heating is performed at a temperature of 1250 to 1280° C. for 3 to 4 h;
in step (3), the perforating is performed at a temperature of 1100 to 1230° C.;
in step (4), the finishing rolling is performed at a temperature of 900 to 1000° C.;
in step (5), the steel pipe is forced-air-cooled to be Ar₃−50° C. or lower, and then is reheated to be 950 to 980° C.;
in step (6), the tension reduction is performed at a temperature of 850 to 900° C.;
in step (7), the straightened steel pipe is allowed to be cooled naturally to room temperature;
in step (9), the tempering is performed at a temperature of (550−2×t° C.); and
in step (10), the straightening is performed at a temperature of ≥400° C.

11. The steel pipe for oil cylinder according to claim 2, wherein the steel pipe for oil cylinder has a wall thickness of greater than or equal to 20 mm, and the steel pipe for oil cylinder comprises Ti: 0.015-0.03% and B: 0.0015-0.0035%.

12. The steel pipe for oil cylinder according to claim 2, wherein in a wall thickness direction of the steel pipe for oil cylinder, a microstructure from an outer wall to a t/2 position is tempered sorbite; a microstructure from the t/2 position to an inner wall is tempered sorbite+ferrite, and the ferrite is distributed in a gradient, and the closer a distance to the inner wall is, the higher the content of the ferrite is; the content of ferrite in the microstructure at the t/2 position is greater than or equal to 3%, and the content of the ferrite in the microstructure at the inner wall is greater than or equal to 5%; wherein t is the wall thickness in mm of the steel pipe for oil cylinder.

13. A method for manufacturing the steel pipe for oil cylinder according to claim 2, comprising the following steps:
(1) smelting and casting:
smelting and casting molten steel having an elemental composition recited in claim 1 to obtain a cast billet;
(2) heating the cast billet;
(3) perforating the heated cast billet;
(4) continuously rolling the perforated cast billet to obtain a steel pipe;
(5) forced-air-cooling and reheating the steel pipe;
(6) performing tension reduction and cooling on the reheated steel pipe:
wherein water cooling is performed on an outer wall of the steel pipe after the tension reduction, and starting cooling temperature of the steel pipe is controlled to be ≥ Ar₃, and finishing cooling temperature of the steel pipe is controlled to be ≥B_{f} and ≤Bₛ−100° C., and cooling rate is controlled to be in a range of 25 to 35° C./s;
(7) straightening the cooled steel pipe;
(8) quenching the straightened steel pipe:
wherein quenching temperature is controlled to be Ac₃+30≤ and ≤Ac₃+60° C., and following the quenching, stepped cooling is performed by means of water cooling while rotating the steel pipe, wherein the water cooling is carried out by performing external water spraying first, and when Ar₃−70° C. ≤ inner wall temperature≤ less than Ar₃−30° C., water is injected into the steel pipe from one end of the steel pipe until the inner hole of the steel pipe is filled with cooling water, and the steel pipe is cooled to room temperature;
(9) tempering the quenched steel pipe; and
(10) straightening the steel pipe after being discharged from a furnace to obtain the steel pipe for oil cylinder.

14. The method according to claim 13, wherein the method meets one or more of the following conditions:
in step (2), the heating is performed at a temperature of 1250 to 1280° C. for 3 to 4 h;
in step (3), the perforating is performed at a temperature of 1100 to 1230° C.;
in step (4), the finishing rolling is performed at a temperature of 900 to 1000° C.;
in step (5), the steel pipe is forced-air-cooled to be Ar₃−50° C. or lower, and then is reheated to be 950 to 980° C.;
in step (6), the tension reduction is performed at a temperature of 850 to 900° C.;
in step (7), the straightened steel pipe is allowed to be cooled naturally to room temperature;
in step (9), the tempering is performed at a temperature of (550-2×t° C.); and
in step (10), the straightening is performed at a temperature of ≥400° C.
